(19) United States
(12) Patent Application Publication
(10) Pub. No.: US 2006/0227864 A1
(43) Pub. Date: Oct. 12, 2006

(54) Contents conversion apparatus and transcode system

(76) Inventors: Hiroki Miyamoto, Fujisawa (JP); Masataka Okayama, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/214,864

(22) Filed: Aug. 31, 2005

(30) Foreign Application Priority Data
Apr. 12, 2005 (JP) 2005-114240

(51) Int. Cl. H04N 11/04; H04N 11/02; H04N 7/12; H04B 1/66

(52) U.S. Cl. 375/240.01

(57) ABSTRACT

Devices connected to a network are caused to conduct transcoding including combination of various coding schemes. A transcoding system includes (information processing) apparatuses, such as STBs, each including a memory unit and a processing unit, and converts a coding scheme of digital contents. The memory unit stores management information acquired from different apparatuses. The management information concerns conversion functions of coding schemes of digital contents concerning the apparatuses, and is information concerning demultiplexing, decoding, encoding and multiplexing. The processing unit determines different apparatuses capable of transcoding digital contents by referring to the management information, and transfers contents data and information indicating processing contents to the different apparatuses, which includes a format conversion unit to execute transcoding according to processing contents sent from the processing unit in an apparatus. Contents subjected to code conversion in the format conversion unit are transmitted to a request source, such as a portable telephone.

### INCORPORATION BY REFERENCE

The present application claims priority from Japanese application JP 2005-114240 filed on Apr. 12, 2005, the content of which is hereby incorporated by reference into this application.

### BACKGROUND OF THE INVENTION

The present invention relates to a contents conversion apparatus and a transcoding system. In particular, the present invention relates to a contents format conversion apparatus, conversion method, and transcoding system for converting the coding scheme of digital contents.

It has become possible to construct a home network in one's house using communication means such as a wired LAN or a wireless LAN and view video digital contents stored in an STB (Set Top Box), a PC (Personal Computer) or the like at a device such as another STB or PC using the network. Furthermore, it is also possible to view video digital contents at a PDA (Personal Digital Assistants) or a portable telephone using a bridge medium such as a SD (Secure Digital) card as means other than the network.

According to the resolution of the screen, processing capability and memory capacity that the device has, the kind of the mounted decoder differs. A large number of kinds of compression coding schemes are mounted on PCs having a high resolution and high processing capability. On a portable telephone having a display screen of QVGA (Quarter Video Graphics Array), a highly compressed compression coding scheme having a small data size of digital contents, such as MPEG-4, is mounted.

Compression coding schemes such as the MPEG include three coding schemes, i.e., moving picture compression coding, audio compression coding, and multiplexing. A large number of formats have been developed for each of them. For example, MPEG-2 PS (Program Stream) utilized for storage type digital contents, MPEG-2 TS (Transport Stream) suitable for communication, and 3GPP (3rd Generation Partnership Project) TS26.234 are multiplexing schemes currently used in general.

In the moving picture compression coding schemes, there are, for example, MPEG-2 video and MPEG-4 visual. In the audio compression coding schemes, there are a large number of formats such as MPEG-2 AAC (Advanced Audio Coding) and MPEG-1 Audio Layer-2. If a coding scheme to be utilized is prescribed in service as in digital broadcast, therefore, there is no problem. If reproducing devices are the same in kind and different in development vendors, however, audio compression coding schemes differ and mutual utilization of digital contents becomes difficult in some cases.

If a decoder differs according to the reproducing device, it is necessary to transcode the compression coding scheme of the digital contents to a scheme capable of coping with it. For example, it is difficult for a commercially available STB, such as a HDD (Hard Disk Drive) recorder, that can be connected to the network to mount a plurality of decoders from the viewpoint of cost. Therefore, the following technique has been proposed. When viewing digital contents on the network that cannot be reproduced, URL information of digital contents and information concerning the STB are transmitted to a transcoding server and digital contents converted into a desired code are generated in the transcoding server. In other words, the transcoding server having various CODECs acquires digital contents on the basis of the URL information, transcodes the acquired digital contents into a coding scheme corresponding to the STB on the basis of the information concerning the STB, and transmits the digital contents obtained after the transcoding to the STB. As a result, the STB can acquire digital contents that can be reproduced.

Such a technique is disclosed in, for example, JP-A-2004-102339 (Pages 4 to 5, and FIG. 1).

In the above-described conventional technique, the transcoding server transcodes digital contents that are present in a contents server into a compression coding scheme that can be reproduced in the STB, and transfers the result. Therefore, it becomes possible even for an STB having a small number of decoders mounted thereon to reproduce digital contents in various compression coding schemes. As a result, it becomes unnecessary for the user to add STBs to the user's purchase one after another for desired digital contents. The user can view the desired digital contents using STBs that the user has possessed until then.

However, the case where the contents server that possesses desired digital contents is an STB and the case where the contents server is connected to the same LAN as an STB, such as a home network on which the STB exists, are not supposed. The above-described conventional technique does not cope with the transcoding of the digital contents possessed by the user.

In the Internet environment, the transcoding server is expected to be accessed from a large number of STBs. This results in a problem that high load processing requests concentrate and the response time to the STBs becomes slow.

An object of the present invention is to conduct transcoding processing of digital contents utilizing a plurality of devices connected to a network.

Another object of the present invention is to prevent processing loads from being concentrated to a specific device, by causing transcoding processing of digital contents to be distributively conducted by a plurality of devices connected to a network.

### SUMMARY OF THE INVENTION

A transcoding system according to the present invention includes a plurality of information processing apparatuses connected to each other via a communication path. The transcoding system converts a coding scheme of digital contents used in the information processing apparatuses. In the transcoding system, each of the information processing apparatuses includes a memory unit for storing management information which is acquired from different information processing apparatuses and which concerns conversion functions of at least coding schemes of digital contents concerning the different information processing apparatuses. Each of the information processing apparatuses includes a processing unit for determining different information processing apparatuses capable of transcoding the digital contents by referring to the management information concerning different information processing apparatuses stored in the memory unit, and transferring contents data required for processing and information indicating contents of the processing to the determined different information processing apparatuses via the communication path. The different information processing apparatuses includes a format conversion unit for executing transcoding according to processing contents sent from the processing unit in a certain information processing apparatus.

This information processing apparatus is a transcoding conversion apparatus. In the embodiments, the information processing apparatus is described as an STB.

In a preferred example, the memory unit stores state indicating information including information concerning performance of different information processing apparatuses, and information concerning demultiplexing, decoding, encoding and multiplexing in coding scheme conversion functions, as the management information. And the processing unit selects a different information processing apparatus having a function of demultiplexing, decoding, encoding or multiplexing for transcoding digital contents according to the management information of different information processing apparatuses, conducts performance evaluation of the selected different information processing apparatus by referring to the management information concerning the selected different information processing apparatus, and transfers necessary contents data and processing contents to the different information processing apparatus which should conduct processing of some function for transcoding digital contents on the basis of a result of the performance evaluation.

In a preferred example, the information processing apparatus includes a DMUX for demultiplexing digital contents into a data stream obtained by conducting compression coding on a moving picture and a data stream obtained by conducting compression coding on a sound. The information processing apparatus includes a decoder for decoding a data stream obtained by conducting compression coding on a moving picture and/or a decoder for decoding a data stream obtained by conducting compression coding on a sound. The information processing apparatus includes an encoder for encoding a data stream obtained by conducting compression coding on a sound and/or an encoder for encoding a data stream obtained by conducting compression coding on a sound. The information processing apparatus includes a MUX responsive to a data stream of a moving picture subjected to compression coding and a data stream of a sound subjected to compression coding input thereto respectively from different information processing apparatuses, for multiplexing both data into a desired multiplexing scheme.

In an example, specification information of processing states, processing speeds of CPUs which conduct transcoding processing on digital contents, and memory sizes in use, of respective information processing apparatuses is stored in the memory unit as device management information, in order to execute performance evaluation on information processing apparatuses and determine an information processing apparatus having a function and a state that are optimum for some processing required for transcoding.

In an example, information of demultiplexing, multiplexing, decoder and encoder included in respective information processing apparatuses is stored in the memory unit as device CODEC management information, in order to determine an information processing apparatus having a function and a state that are optimum for some processing required for transcoding by executing performance evaluation on the information processing apparatuses.

In an example, the processing unit conducts performance evaluation on different information processing apparatuses by referring to the management information concerning the different information processing apparatuses, and determines a different information processing apparatus that should conduct processing of some function for transcoding digital contents so as to distribute load among a plurality of information processing apparatuses on the basis of a result of the performance evaluation.

In an example, the format conversion unit conducts conversion on at least one of a multiplexing scheme, a moving picture compression coding scheme, and a sound compression coding scheme.

In an example, the processing unit in the information processing apparatus includes a communication control unit connected to the communication path, and the communication control unit receives a transcoding request of digital contents from an external apparatus, and transmits contents data subjected to format conversion in the format conversion apparatus to the external apparatus.

A format conversion method according to the present invention is a format conversion method of contents for converting a coding scheme of digital contents used in a plurality of information processing apparatuses connected to each other via a communication path. The format conversion method includes Steps of storing management information which is acquired from different information processing apparatuses and which concerns conversion functions of at least coding schemes of digital contents concerning the different information processing apparatuses, in a memory unit, determining different information processing apparatuses capable of transcoding the digital contents by referring to the management information concerning different information processing apparatuses stored in the memory unit in response to a transcoding request of digital contents from a request source, and transferring contents data required for processing and information indicating contents of the processing to the determined different information processing apparatuses via the communication path. The different information processing apparatuses execute a format conversion step of executing transcoding according to processing contents sent from a processing unit in a certain information processing apparatus, and a step of transmitting contents data subjected to format conversion to the request source.

In a preferred example, state indicating information including information concerning performance of different information processing apparatuses, and information concerning demultiplexing, decoding, encoding and multiplexing in coding scheme conversion functions are stored as the management information. The processing unit is caused to select a different information processing apparatus having a function of demultiplexing, decoding, encoding or multiplexing for transcoding digital contents according to the management information of different information processing apparatuses, conduct performance evaluation of the selected different information processing apparatus by referring to the management information concerning the selected different information processing apparatus, and transfer necessary contents data and processing contents to the different information processing apparatus which should conduct processing of some function for transcoding digital contents on the basis of a result of the performance evaluation.

A transcoding conversion apparatus according to the present invention is a transcoding conversion apparatus connected to different transcoding conversion apparatuses and an external apparatus via a communication path. The transcoding conversion apparatus converts a coding scheme of requested digital contents. The transcoding conversion apparatus includes a memory unit for storing management information which is acquired from different transcoding conversion apparatuses and which concerns conversion functions of at least coding schemes of digital contents concerning the different transcoding conversion apparatuses, a processing unit for determining different transcoding conversion apparatuses capable of transcoding the digital contents by referring to the management information concerning different transcoding conversion apparatuses stored in the memory unit, and conducting processing for generating information concerning code conversion assigned to different transcoding conversion apparatuses, a communication control unit for transmitting contents data required for processing and information indicating contents of the processing to the different information processing apparatuses determined by the processing unit via the communication path, and transmitting contents subjected to format conversion processing, and a format conversion unit for executing format conversion of contents according to contents data requested to conduct processing and processing contents.

In a preferred example, the memory unit stores a table of device management information including specification information of processing states, processing speeds of CPUs which conduct transcoding processing on digital contents, and memory sizes in use, of respective transcoding conversion apparatuses, a table of device CODEC management information including information of demultiplexing, multiplexing, decoder and encoder included in respective transcoding conversion apparatuses, and a table of information indicating a relation between coding schemes used for digital contents before and after conversion.

According to the present invention, various kinds of transcoding corresponding to a plurality of kinds of coding schemes is made possible by executing transcoding processing of digital contents utilizing a plurality of devices connected to a network. Furthermore, it is possible to prevent the load of processing from concentrating to a certain place by causing a plurality of devices to conduct transcoding processing according to the state.

### BRIEF DESCRIPTION OF THE DRAWINGS

These and other features, objects and advantages of the present invention will become more apparent from the following description when taken in conjunction with the accompanying drawings wherein:

FIG. 1 is a configuration diagram of a transcoding system in an embodiment;

FIG. 2 is a hardware configuration diagram of an STB 10 in the embodiment;

FIG. 3 is a diagram showing an example of a table configuration example for device management information 50 in the embodiment;

FIG. 4 is a diagram showing an example of a table configuration for device CODEC management information 60 in the embodiment;

FIG. 5 is a diagram showing an example of a table configuration for conversion information 70 in the embodiment;

FIG. 6 is a diagram showing an example of a table configuration for request destination management information in the embodiment;

FIG. 7 is a flow chart diagram showing operation conducted from a portable telephone to request digital contents from an STB, in the embodiment;

FIG. 8 is a flow chart diagram showing an operation procedure for transcoding in the embodiment; and

FIG. 9 is a flow chart diagram showing an operation procedure for transcoding in another embodiment.

### DETAILED DESCRIPTION OF THE EMBODIMENTS

Embodiments of the present invention will be described with reference to the drawings.

FIG. 1 is a diagram showing a configuration example of a transcoding system according to an embodiment.

In the transcoding system shown in FIG. 1, 10a to 10e denote STBs, 20 a LAN, and 30 a portable telephone.

A suffix (“a” to “e”) of the STB 10 is provided to discriminate the five devices for the convenience of description. There is no difference among those devices in that the STB devices have an STB function. In MUXs (multiplexers), DMUXs (demultiplexers), decoders and encoders mounted on the STBs 10, the same format may be mounted or different formats may be mounted. In the case where any of the STBs 10a to 10e is not specified, the STB is represented by STB 10 as representative one.

The STB 10 has a function of automatically acquiring states, specifications, information of the encoders and decoders in other STBs 10 connected to the STB 10 via the LAN 20, and requesting STBs 10 including itself connected to the LAN 20 on the basis of acquired states and information in the mounted decoder and encoder to conduct processing of demultiplexing, audio stream conversion, video stream conversion and multiplexing required to transcode digital contents. The requested STB 10 has a function of controlling the transcoding by executing the requested processing.

The LAN 20 is a network formed using a wired LAN, a wireless LAN, a UWB (Ultra Wide Band), Bluetooth, or a power line. Between apparatuses connected to the LAN 20, it becomes possible to transfer data according to a certain predetermined procedure.

The portable telephone 30 is a device that issues a transcoding request for digital contents. By the way, a different device (not illustrated), such as a PDA or an STB, may also be used instead of the portable telephone 30.

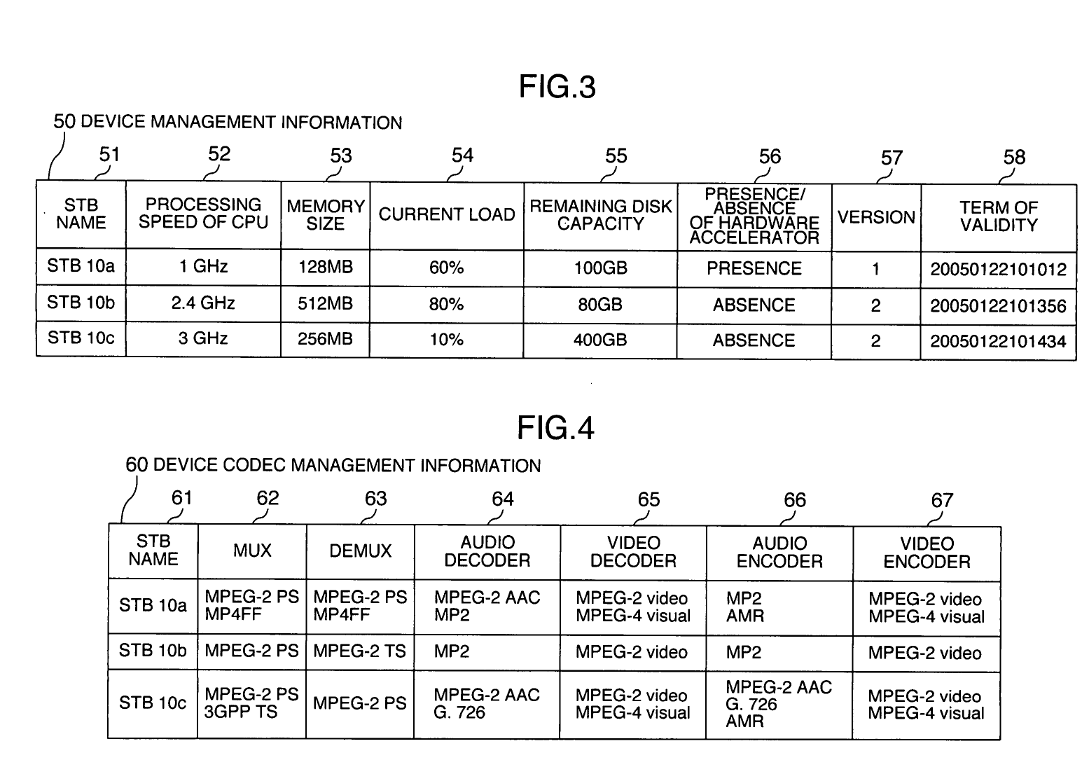

In the transcoding system according to the present embodiment, each of the STBs connected to each other via the LAN 20 has at least one decoder for the audio compression coding scheme, at least one decoder for the moving picture compression coding scheme, at least one encoder for the audio compression coding scheme, at least one encoder for the moving picture compression coding scheme, at least one MUX and at least DMUX mounted thereon. In addition, a function such as UPnP (Universal Plug and Play) capable of automatically detecting the mutual existence and provided service is mounted. The STBs 10a to 10e automatically acquire information concerning the states, specifications and conversion functions of STBs 10 that can be connected thereto, register those kinds of information in tables 50 and 60 (described later with reference to FIGS. 3 and 4), and manage those kinds of information. If there is a change in registered information, contents of the tables are updated successively.

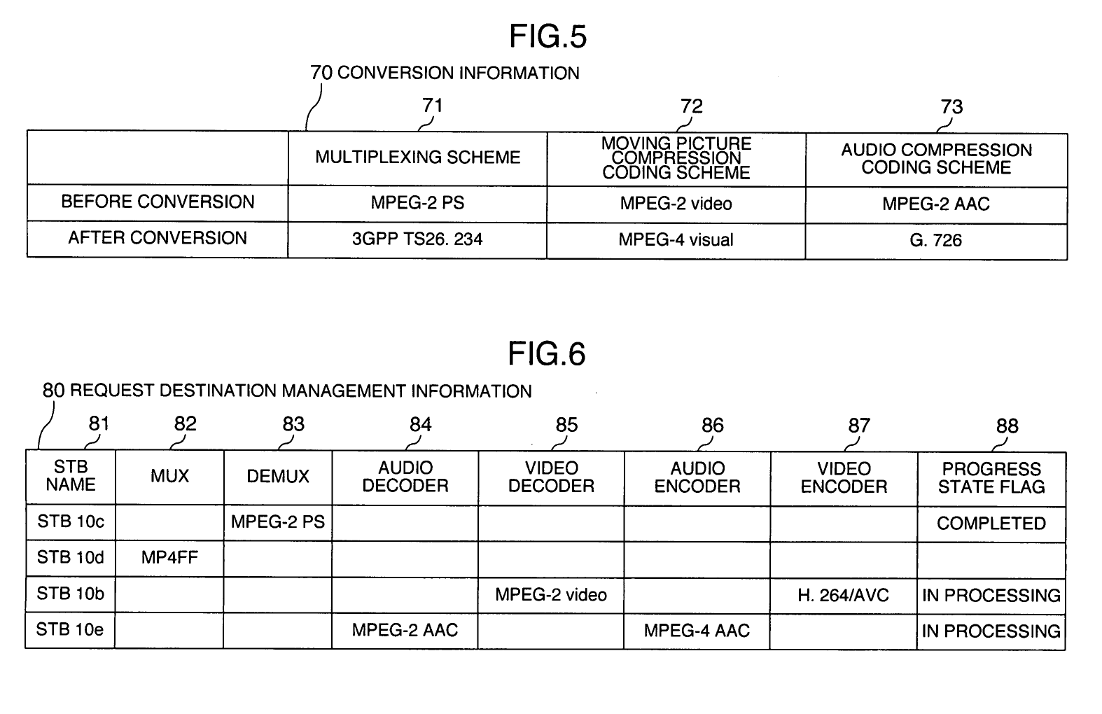

For example, if the portable telephone 30 requests the STB 10a to transcode digital contents, a conversion pair table 70 (described later with reference to FIG. 5), in which coding schemes before and after conversion have been registered, is generated by an STB 10 serving as a request source. With an STB 10 having specified digital contents as the starting point, before executing processing of demultiplexing, audio/video stream conversion and multiplexing on the digital contents, an STB 10 capable of conducting processing is selected on the basis of information collected from STBs 10 and performance evaluation is conducted. According to a result of performance evaluation, an optimum STB 10 is determined for each processing. Conversion pair information registered in the conversion pair table 70 and a stream of digital contents that becomes the subject in each processing are transferred to the determined STB 10. Upon receiving the transferred information and stream, the STB 10 executes code conversion processing according to requested processing contents.

In this way, it is possible to implement a transcoding system that conducts processing of demultiplexing, conversion of audio/video stream, and multiplexing concerning some digital contents, utilizing a plurality of STBs.

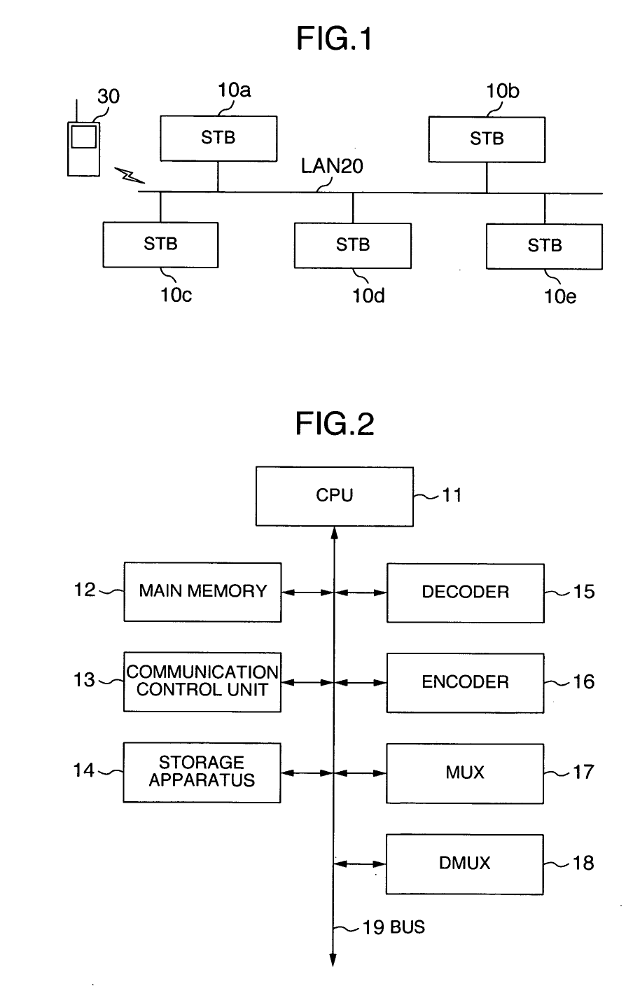

FIG. 2 is a hardware configuration diagram of an STB 10 in the present embodiment.

As shown in FIG. 2, the STB 10 includes a CPU 11, a main memory 12, a communication control unit 13, a storage apparatus 14, a decoder 15, an encoder 16, a MUX 17, and a DMUX 18. Components in the STB 10 are connected to each other by a bus 19. Necessary information can be transferred between components.

The CPU 11 conducts predetermined processing operation by executing programs previously stored in the main memory and the storage apparatus 14. The main memory 12 is a memory for functioning as a work area and storing necessary programs. For example, the main memory 12 can be implemented using a RAM (Random Access Memory) for the work area, and it can be implemented using a ROM (Read Only Memory) for program storage.

The communication control unit 13 is a unit for transmitting data to and receiving data from another apparatus connected to the LAN 20. The communication control unit is implemented using, for example, a modem, a network adapter, or a wireless transceiver apparatus. The storage apparatus 14 is a storage storing a program for controlling the operation of the STB 10 and storing digital contents delivered via the LAN 20. The storage apparatus 14 is implemented using, for example, an HDD or an optical disk.

The decoder 15 is a unit for conducting decoding processing on an audio stream or a video stream subjected to compression coding. The decoder 15 is implemented using, for example, a hardware accelerator. The encoder 16 is a unit for conducting encoding processing on an audio stream that is not encoded or a video stream that is not encoded. The encoder 16 is implemented using, for example, a hardware accelerator.

The MUX 17 is a unit for conducting multiplexing processing on an audio stream or a video stream subjected to compression coding. The MUX 17 is implemented using, for example, a hardware accelerator. The DMUX 18 is a unit for conducting demultiplexing processing on an audio stream or a video stream subjected to compression coding. The DMUX 18 is implemented using, for example, a hardware accelerator.

The decoder 15, the encoder 16, the MUX 17 and the DMUX 18 are not restricted to hardware, but may also be implemented using software. In that case, programs required to implement those functions are stored in the main memory 12 or the storage apparatus 14. A desired function can be implemented by executing a necessary program in the CPU 11 as occasion demands.

Management information used in transcoding processing according to the present invention will now be described with reference to FIGS. 3 to 6.

As the management information, device management information 50 utilized for performance evaluation, device CODEC management information 60, conversion information 70 and request destination management information 80 can be mentioned. The device management information 50, the device CODEC management information 60, the conversion information 70 and the request destination management information 80 are stored in the main memory 12 or the storage apparatus 14 (hereafter, both are collectively referred to as memory unit in some cases) and managed.

FIG. 3 shows a table configuration example of the device management information 50 utilized for performance evaluation.

The device management information 50 includes information indicating an STB name 51 to be evaluated, a CPU processing speed 52, a memory size 53, a current load 54, a remaining disk capacity 55, presence/absence of hardware accelerator 56, a version 57, and a term of validity 58.

Each STB 10 periodically multi-casts the version 57 in the device management information 50. Typically, each STB 10 can determine whether the device management information 50 possessed by itself is the latest one by comparing version information that is multi-cast with a numeral in the version 57 in the device management information 50. If the version acquired by the multi-cast is greater than the version 57, the STB 10 having the device management information 50 reacquires device management information 50.

The term of validity 58 is utilized to detect whether the STB 10 is dead or alive. If the term of validity 58 of the version 57 has expired, all items for the STB 10 that has expired in term of validity are deleted from the device management information 50. If the STB 10 is present in the list the device management information 50, connection to the STB 10 via the network is possible. If the STB 10 is not present in the list the device management information 50, however it can be judged that the STB 10 is in an environment in which the STB 10 cannot be utilized.

By the way, if a new STB is connected to the LAN 20, the connection is detected and the device management information 50 of the STB is automatically acquired.

FIG. 4 shows a table configuration example of the device CODEC management information 60.

The device CODEC management information 60 includes information indicating an STB name 61 that becomes a subject, a MUX 62, a DMUX 63, an audio decoder 64, a video decoder 65, an audio encoder 66, and a video encoder 67.

It is possible to determine whether target processing is executable and acquire a list of STBs 10 required for performance evaluation by referring to the management information 60 before conducting performance evaluation of STBs. The device management information 50 and the device CODEC management information 60 are interlocked with each other. If the term of validity 58 in the device management information 50 has expired, the pertinent STB 10 is judged to be off in power or disconnected from the network and all items of the STB 10 in the device CODEC management information are deleted.

By the way, as for the device management information 50 and the device CODEC management information 60, the method of managing them in respective STBs 10 may not be used. For example, when these kinds of information are necessary, an acquisition request may be issued to respective STBs 10 to acquire the latest device management information 50 and the device CODEC management information 60. If in that case the term of validity 58 and the version 57 in the device management information are not necessary in operation, they may not be used.

For conducting performance evaluation using the device management information 50, STBs 10 that can execute desired conversion are listed utilizing the device CODEC management information 60. In each of the STBs 10 in the list, performance evaluation is conducted utilizing the device management information 50.

Hereafter, an example of evaluation will be described.

As for the CPU speed 52 and the memory size 53, marks 1, 2, 3 . . . are given in the order of decreasing value. As for the current load 54, marks 1, 2, 3 . . . are given in the order of increasing value. These marks are added up for each STB name 61. An STB having the lowest value becomes an STB 10 having the highest evaluation. If the values have become the same, an STB 10 having a greater remaining disk capacity becomes an STB 10 having the highest evaluation. If STBs 10 in the list have a hardware accelerator mounted on them, evaluation concerning the current load 54 is conducted on the STBs 10 having the hardware accelerator. Processing can be distributed so as to balance the load among a plurality of STBs 10 with reference to the current load 54.

The processing operation for evaluating performance of STBs 10 and operation for assigning the processing of demultiplexing concerning digital contents, audio/video stream conversion and multiplexing to STBs 10 utilizing the management information 50 and 60 are conducted by executing a program in the CPU 11 in an STB 10.

FIG. 5 shows a table configuration example of the conversion information 70.

The conversion information 70 includes a multiplexing scheme 71, a moving picture compression coding scheme 72 and an audio compression coding scheme 73. Information indicating coding schemes before and after conversion of digital contents is previously registered. When the STB 10 conducts conversion processing, the STB refers to the conversion information 70 and executes the conversion. For example, as for the multiplexing scheme 71, it is meant that the MPEG-2PS is converted to the 3GPP TS26.234.

FIG. 6 shows a table configuration example of the request destination management information 80.

This table 80 is formed in an STB 10 that has received a contents acquisition request from the portable telephone 30. The table 80 is a table for managing request contents of STBs 10 serving as request destinations of code conversion processing concerning requested contents. The illustrated example shows contents of a table developed in the STB 10a.

As for the request destination management information, information of MUX 82, DMUX 83, audio decoder 84, video decoder 85, audio encoder 86 and video encoder 87 which indicate requested functions, and a progress state flag 88 which indicates the progress situation of code conversion processing is registered so as to be associated with an STB name 81 serving as a request destination.

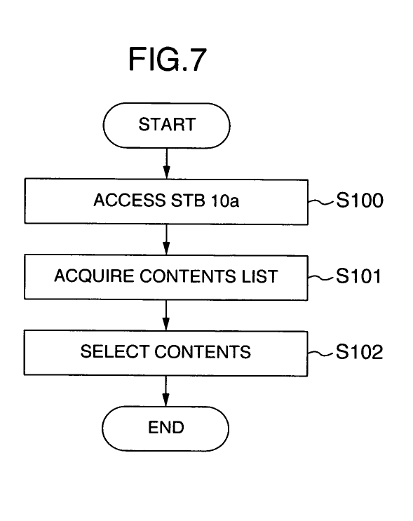

An example in which digital contents converted in coding is acquired according to a request from the portable telephone 30 will now be described with reference to FIG. 7.

Here, the portable telephone 30 and the STBs 10a to 10e are devices corresponding to UPnP. Furthermore, it is now supposed that digital contents desired by the user are present in the STB 10c.

First, the portable telephone 30 accesses the STB 10a utilizing the wireless LAN, Bluetooth, UWB or the like (S100). If the portable telephone is connected to the LAN 20, the STBs 10a to 10e automatically detect the portable telephone 30. If it becomes possible for the portable telephone 30 to access the STB 10a, the portable telephone 30 requests the STB 10a to acquire a contents list utilizing a user interface in the portable telephone 30. If the STBs 10a, 10b and 10c are devices corresponding to the DLNA (Digital Living Network Alliance), the STB 10a can acquire contents lists of the STBs 10b and 10c as well. Even if they are not devices corresponding to the DLNA, it is also possible to acquire contents list using a peculiar protocol (S101). The contents list acquired by the STB 10a is transmitted to the portable telephone 30. Here, the contents list may be regarded as a list including a contents name and its URL.

A user of the portable telephone 30 selects desired digital contents from the acquired contents list utilizing the graphic user interface and buttons on the portable telephone 30. Information capable of uniquely specifying the selected digital contents, such as a contents name or its URL, and a list of information indicating compression coding schemes that can be reproduced in the portable telephone 30 are transmitted from the portable telephone 30 to the STB 10a (S102).

In this example, the case where digital contents are acquired according to a request from the portable telephone 30 is described. However, not only the portable telephone 30, but also a terminal apparatus such as a car navigation apparatus or a PDA connected by a wireless LAN may issue a request. In this case, it is necessary to mount a player having a function of being connected to the network and capable of storing digital contents and reproducing digital contents encoded in some compression coding scheme.

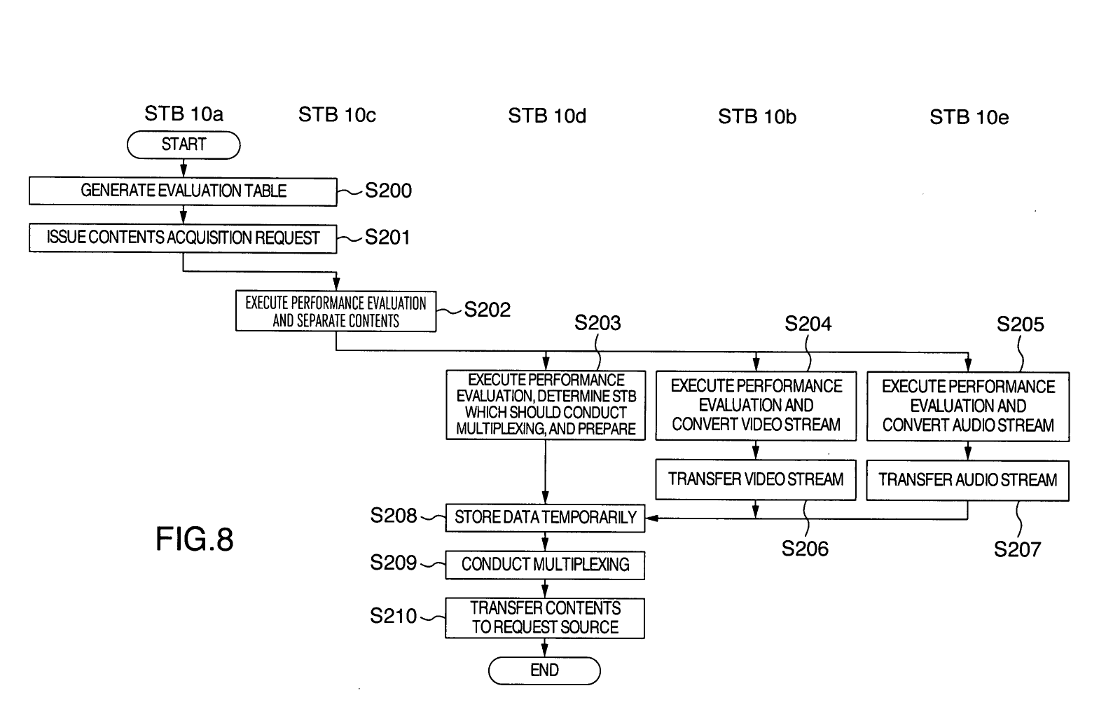

Conversion processing for transcoding digital contents in an embodiment will now be described with reference to FIG. 8.

For example, if power is turned on in an STB 10, an evaluation table is first generated (S200). The evaluation table is a table of the device management information 50 and the device CODEC management information 60. STBs 10 recognize each other using UPnP, and acquire all of the device management information 50 of an STB 10 that is multi-casting the version. The device management information 50 acquired by each STB 10 always becomes latest information by operation of the version 57 and the term of validity 58.

As described above, instead of managing the device management information 50 by utilizing the version 57 and the term of validity 58, an acquisition request may be issued to respective STBs 10 immediately before the performance evaluation to collect the device management information 50 and the device CODEC management information 60.

Subsequently, the STB 10a which has received a set of a contents name and a corresponding compression coding scheme from the portable telephone 30 at Step S102 (FIG. 7) transmits the contents name and a compression coding scheme to be converted, to the STB 10c which possesses the digital contents as a coding scheme conversion request (S201). At this stage, in the table of the request destination management information 80 in the STB 10a, MPEG-2PS which becomes request contents is registered in the corresponding item DEMUX 83 of the STB 10c. Thereafter, the STB 10 which is a request destination and request contents are successively registered in this table using a similar method.

Upon receiving the coding scheme conversion request, the STB 10c generates conversion information 70 on the basis of a list of the transmitted compression coding scheme and digital contents to be subjected to conversion processing. In addition, the STB 10c conducts performance evaluation with reference to the conversion information 70 and the device management information 50 and the device CODEC management information 60 possessed by the STB 10c. The STB 10c determines an STB 10 (which is supposed to be STB 10c for convenience) capable of separating digital contents to be converted, according to the evaluation. The digital contents and the conversion information 70 are transmitted to the STB 10c. Upon receiving the conversion information 70 and the digital contents, the STB 10c executes demultiplexing processing (S202).

Subsequently, the STB 10c executes performance evaluation to determine an STB 10 which should conduct multiplexing, and requests the determined STB 10 (which is now supposed to be the STB 10d) to prepare for multiplexing processing. As for the preparation, specifically, the STB 10d executes the capacity check of the HDD to store a video stream and an audio stream, and the STB 10d is brought into the standby state (S203).

The STB 10c executes performance evaluation on the video stream and the audio stream obtained at Step S202, determines an STB 10 (which is now supposed to be STB 10b) capable of converting the video stream according to the conversion information 70, and transmits a conversion request to the STB 10b. Upon being requested, the STB 10b executes conversion processing. At the time of the conversion request, information indicating the STB 10d which should execute multiplexing determined at Step S203 is also transmitted together with the video stream (S204).

In addition, the STB 10c determines an STB 10 (which is now supposed to be STB 10e) capable of converting the audio stream according to the conversion information 70, and transmits a conversion request to the STB 10e. Upon being requested, the STB 10e executes conversion processing. At the time of the conversion request, information indicating the STB 10d which should execute multiplexing determined at Step S203 is also transmitted together with the audio stream (S205).

By the way, it is supposed that each of the conversion of the moving picture stream at Step S204 and the conversion of the audio stream at Step S205 is executed in the same STB 10. Besides this method, however, it is also possible to execute performance evaluation for determining an STB 10 that should decode the video stream, execute a decoding processing request, execute performance evaluation to find out an STB 10 capable of conducting encoding processing, and execute the encoding. In this case, it becomes possible to transcode a larger number of kinds of coding schemes.

Subsequently, the video stream and the audio stream are transmitted to the STB 10d which is ready for multiplexing, on the basis of information indicating the STB 10d which should execute multiplexing transmitted at Step S204 and Step S205 (S206 and S207).

In the STB 10d, the transmitted streams are temporarily stored on the HDD (S208). If a video stream and an audio stream of at least a predetermined amount can be ensured, the STB 10d executes a multiplexing work (S209). If the multiplexing is finished, contents subjected to code conversion are transmitted to the portable telephone 30 which has issued the contents acquisition request, via the STB 10a (S210).

By the way, if the processing is finished, the flag 88 which indicates the progress state in the table of the request destination management information 80 is changed from “in processing” to “completed” in a column corresponding to the STB 10. Therefore, the STB 10a can determine whether all of the requested processing is completed with reference to the flag 88.

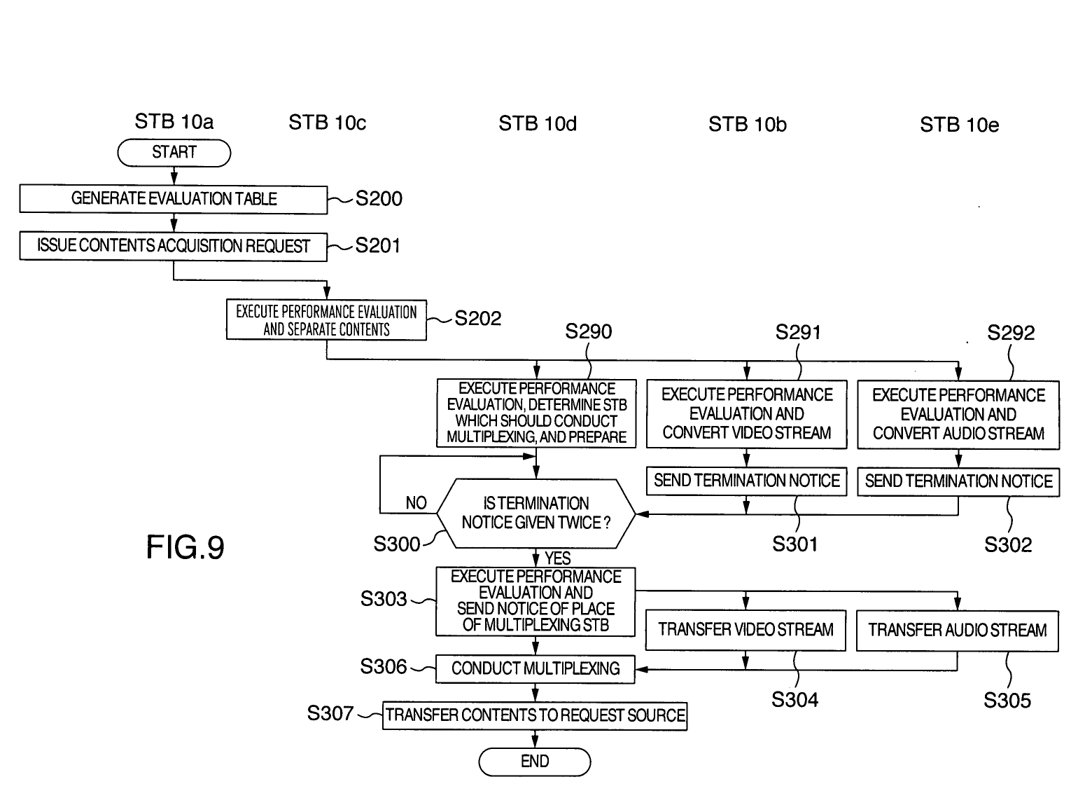

Conversion processing for transcoding digital contents in another embodiment will now be described with reference to FIG. 9.

Steps S200 to S202 shown in FIG. 9 are the same as those in FIG. 8.

At Step S290, the STB 10c executes performance evaluation to determine an STB 10 which should conduct multiplexing, and requests the determined STB 10d to prepare for multiplexing processing. As for the preparation, the STB 10d executes the capacity check of the HDD to store a video stream and an audio stream. Thereafter, the STB 10d is brought into the standby state until a termination notice of the video stream conversion and the audio stream conversion is given.

The STB 10c executes performance evaluation on the video stream and the audio stream obtained at Step S202, determines an STB 10 (which is now supposed to be STB 10b) capable of converting the video stream according to the conversion information 70, and transmits a conversion request to the STB 10b. Upon being requested, the STB 10b executes conversion processing (S291). At the time of the conversion request, information indicating the STB 10d which should execute multiplexing determined at Step S290 is also transmitted together with the video stream.

In addition, the STB 10c determines an STB 10 (which is now supposed to be STB 10e) capable of converting the audio stream according to the conversion information 70, and transmits a conversion request to the STB 10e. Upon being requested, the STB 10e executes conversion processing. At the time of the conversion request, information indicating the STB 10d which should execute multiplexing determined at Step S203 is also transmitted together with the audio stream (S292).

If the conversion of the video stream is finished, the STB 10d is notified that the video stream conversion processing has been terminated, on the basis of the information indicating the STB 10d which should execute multiplexing acquired at Step S291 (S301). At this time, the video stream after the conversion is stored in the storage apparatus 14 in the STB 10b.

If the conversion of the audio stream is finished, the STB 10d is notified that the audio stream conversion processing has been terminated, on the basis of the information indicating the STB 10d which should execute multiplexing acquired at Step S292 (S302). At this time, the audio stream after the conversion is stored in the storage apparatus 14 in the STB 10e.

The STB 10d receives termination notices transmitted at Step S301 and Step S302. Unless both the termination notice of the video stream and the termination notice of the audio stream are given, the STB 10d is in a waiting state. Upon receiving both termination notices, the STB 10d proceeds to Step S303.

In order to find out an STB 10 that is optimum for the multiplexing processing again when the coding scheme conversion of the video stream and the coding scheme conversion of the audio stream have been terminated, the STB 10d determined as the multiplexing processing STB 10 at Step S290 executes performance evaluation, and determines one from among STBs connected to the communication network. (It is now supposed that the STB 10d has been determined again.) The STB 10d which has executed the performance evaluation transmits information indicating the STB 10 (which is now supposed to be STB 10d) which should newly execute the multiplexing processing to the STB 10b and STB 10e which have sent the termination notices at Step S300 (S303).

As for the transmission of the information indicating the STB 10d, the STB 10 that has executed the performance evaluation may execute the transmission, or the STB 10 that should newly execute multiplexing processing may execute the transmission.

Upon receiving the information indicating the STB 10d which should execute the multiplexing processing, the STB 10b and the STB 10e respectively transmit the video stream and the audio stream on the basis of the information indicating the STB 10d (S304 and S305). And the STB 10d multiplexes the video stream transmitted from the STB 10b which has converted the coding of the video stream and the audio stream transmitted from the STB 10e which has converted the coding of the audio stream, and converts them into one unit of digital contents (S306).

Upon terminating the conversion processing, the STB 10d transfers the digital contents obtained after the transcoding to the portable telephone 30 via the STB 10a (S307), and terminates the transcoding processing.

According to this embodiment, the latest one of state information of STBs 10 that varies every moment is referred to and performance evaluation of respective STBs is conducted. On the basis of the evaluation, an STB 10 that is optimum for executing the multiplexing processing is determined at Step S303 again. Therefore, optimum distribution processing among the STBs 10 can be conducted. Especially, it takes at least one hour to encode video data. There is a possibility that the state information will also vary during that time. Accordingly, it is effective to apply this embodiment.

According to the above-described embodiments, the transcoding processing of digital contents is conducted distributively utilizing a plurality of STBs connected to a network. As a result, the number of coding schemes that can be transcoded is increased. Therefore, coding scheme conversion that could not be conducted in one STB also becomes possible utilizing other STBs. Furthermore, since another STB can acquire management information of each STB and determine an STB that should conduct conversion processing, it is possible to prevent conversion processing from concentrating to one place.

Heretofore, embodiments of the present invention have been described. However, the present invention is not restricted to the above-described embodiments. It is a matter of course that various other configurations may be taken without departing from the spirit of the present invention.

As middleware or applications in digital home electric appliances, such as HDD recorders, home servers, PCs, PDA and portable telephones, the embodiments can be mounted on these appliances and applied to them.

While we have shown and described several embodiments in accordance with our invention, it should be understood that disclosed embodiments are susceptible of changes and modifications without departing from the scope of the invention.

Therefore, we do not intend to be bound by the details shown and described herein but intend to cover all such changes and modifications a fall within the ambit of the appended claims.

1. A transcoding system including a plurality of information processing apparatuses connected to each other via a communication path, the transcoding system converting a coding scheme of digital contents used in the information processing apparatuses,
wherein each of the information processing apparatuses comprises:
a memory unit which stores management information which is acquired from different information processing apparatuses and which concerns conversion functions of at least coding schemes of digital contents concerning the different information processing apparatuses; and
a processing unit which determines different information processing apparatuses capable of transcoding the digital contents by referring to the management information concerning different information processing apparatuses stored in the memory unit, and transfers contents data required for processing and information indicating contents of the processing to the determined different information processing apparatuses via the communication path, and
wherein the different information processing apparatuses comprise:
a format conversion unit which executes transcoding according to processing contents sent from the processing unit in a certain information processing apparatus.

2. The transcoding system according to claim 1, wherein:
the memory unit stores state indicating information including information concerning performance of different information processing apparatuses, and information concerning demultiplexing, decoding, encoding and multiplexing in coding scheme conversion functions, as the management information, and
the processing unit selects a different information processing apparatus having a function of demultiplexing, decoding, encoding or multiplexing for transcoding digital contents according to the management information of different information processing apparatuses, conducts performance evaluation of the selected different information processing apparatus by referring to the management information concerning the selected different information processing apparatus, and transfers necessary contents data and processing contents to the different information processing apparatus which should conduct processing of some function for transcoding digital contents on the basis of a result of the performance evaluation.

3. The transcoding system according to claim 1, wherein the information processing apparatus comprises a DMUX which demultiplexes digital contents into a data stream obtained by conducting compression coding on a moving picture and a data stream obtained by conducting compression coding on a sound.

4. The transcoding system according to claim 1, wherein the information processing apparatus comprises a decoder which decodes a data stream obtained by conducting compression coding on a moving picture and/or a decoder which decodes a data stream obtained by conducting compression coding on a sound.

5. The transcoding system according to claim 1, wherein the information processing apparatus comprises an encoder which encodes a data stream obtained by conducting compression coding on a sound and/or an encoder which encodes a data stream obtained by conducting compression coding on a sound.

6. The transcoding system according to claim 1, wherein the information processing apparatus comprises a MUX responsive to a data stream of a moving picture subjected to compression coding and a data stream of a sound subjected to compression coding input thereto respectively from different information processing apparatuses, which MUX multiplexes both data into a desired multiplexing scheme.

7. The transcoding system according to claim 2, wherein specification information of processing states, processing speeds of CPUs which conduct transcoding processing on digital contents, and memory sizes in use, of respective information processing apparatuses is stored in the memory unit as device management information, in order to execute performance evaluation on information processing apparatuses and determine an information processing apparatus having a function and a state that are optimum for some processing required for transcoding.

8. The transcoding system according to claim 2, wherein information of demultiplexing, multiplexing, decoder and encoder included in respective information processing apparatuses is stored in the memory unit as device CODEC management information, in order to determine an information processing apparatus having a function and a state that are optimum for some processing required for transcoding by executing performance evaluation on the information processing apparatuses.

9. The transcoding system according to claim 2, wherein the processing unit conducts performance evaluation on different information processing apparatuses by referring to the management information concerning the different information processing apparatuses, and determines a different information processing apparatus that should conduct processing of some function for transcoding digital contents so as to distribute load among a plurality of information processing apparatuses on the basis of a result of the performance evaluation.

10. The transcoding system according to claim 1, wherein the format conversion unit conducts conversion on at least one of a multiplexing scheme, a moving picture compression coding scheme, and a sound compression coding scheme.

11. The transcoding system according to claim 1, wherein:
the processing unit in the information processing apparatus comprises a communication control unit connected to the communication path, and
the communication control unit receives a transcoding request of digital contents from an external apparatus, and transmits contents data subjected to format conversion in the format conversion apparatus to the external apparatus.

12. A format conversion method of contents for converting a coding scheme of digital contents used in a plurality of information processing apparatuses connected to each other via a communication path, the format conversion method comprising Steps of:
storing management information which is acquired from different information processing apparatuses and which concerns conversion functions of at least coding schemes of digital contents concerning the different information processing apparatuses, in a memory unit; and
determining different information processing apparatuses capable of transcoding the digital contents by referring to the management information concerning different information processing apparatuses stored in the memory unit in response to a transcoding request of digital contents from a request source, and transferring contents data required for processing and information indicating contents of the processing to the determined different information processing apparatuses via the communication path, and
wherein the different information processing apparatuses execute:
a format conversion step of executing transcoding according to processing contents sent from a processing unit in a certain information processing apparatus; and
a step of transmitting contents data subjected to format conversion to the request source.

13. The format conversion method according to claim 12, wherein:
state indicating information including information concerning performance of different information processing apparatuses, and information concerning demultiplexing, decoding, encoding and multiplexing in coding scheme conversion functions are stored as the management information, and
the processing unit is caused to select a different information processing apparatus having a function of demultiplexing, decoding, encoding or multiplexing for transcoding digital contents according to the management information of different information processing apparatuses, conduct performance evaluation of the selected different information processing apparatus by referring to the management information concerning the selected different information processing apparatus, and transfer necessary contents data and processing contents to the different information processing apparatus which should conduct processing of some function for transcoding digital contents on the basis of a result of the performance evaluation.

14. The format conversion method according to claim 12, wherein specification information of processing states, processing speeds of CPUs which conduct transcoding processing on digital contents, and memory sizes in use, of respective information processing apparatuses is stored in the memory unit as device management information, in order to execute performance evaluation on the different information processing apparatuses and determine an information processing apparatus having a function and a state that are optimum for some processing required for transcoding.

15. The format conversion method according to claim 12, wherein information of demultiplexing, multiplexing, decoder and encoder included in respective information processing apparatuses is stored in the memory unit as device CODEC management information, in order to determine an information processing apparatus having a function and a state that are optimum for some processing required for transcoding by executing performance evaluation on the information processing apparatuses.

16. A transcoding conversion apparatus connected to different transcoding conversion apparatuses and an external apparatus via a communication path, the transcoding conversion apparatus converting a coding scheme of requested digital contents, the transcoding conversion apparatus comprising:
a memory unit which stores management information which is acquired from different transcoding conversion apparatuses and which concerns conversion functions of at least coding schemes of digital contents concerning the different transcoding conversion apparatuses;
a processing unit which determines different transcoding conversion apparatuses capable of transcoding the digital contents by referring to the management information concerning different transcoding conversion apparatuses stored in the memory unit, and conducts processing for generating information concerning code conversion assigned to different transcoding conversion apparatuses;
a communication control unit which transmits contents data required for processing and information indicating contents of the processing to the different information processing apparatuses determined by the processing unit via the communication path, and transmits contents subjected to format conversion processing; and
a format conversion unit which executes format conversion of contents according to contents data requested to conduct processing and processing contents.

17. The transcoding conversion apparatus according to claim 16, wherein:
the memory unit stores state indicating information including information concerning performance of different transcoding conversion apparatuses, and information concerning demultiplexing, decoding, encoding and multiplexing in coding scheme conversion functions, as the management information, and
the processing unit selects a different transcoding conversion apparatus having a function of demultiplexing, decoding, encoding or multiplexing for transcoding digital contents according to the management information of different transcoding conversion apparatuses, conducts performance evaluation of the selected different transcoding conversion apparatus by referring to the management information concerning the selected different transcoding conversion apparatus, and conducts processing of determining a different transcoding conversion apparatus which should conduct processing of some function for transcoding digital contents on the basis of a result of the performance evaluation.

18. The transcoding conversion apparatus according to claim 17, wherein the format conversion unit comprises at least one of a DMUX, a decoder, an encoder and a MUX for transcoding the digital contents.

19. The transcoding conversion apparatus according to claim 16, wherein the format conversion unit conducts conversion on at least one of a multiplexing scheme, a moving picture compression coding scheme, and a sound compression coding scheme.

20. The transcoding conversion apparatus according to claim 16, wherein the memory unit stores:
a table of device management information including specification information of processing states, processing speeds of CPUs which conduct transcoding processing on digital contents, and memory sizes in use, of respective transcoding conversion apparatuses;
a table of device CODEC management information including information of demultiplexing, multiplexing, decoder and encoder included in respective transcoding conversion apparatuses; and
a table of information indicating a relation between coding schemes used for digital contents before and after conversion.
